(19) United States
(12) Patent Application Publication
(10) Pub. No.: US 2017/0046902 A1
(43) Pub. Date: Feb. 16, 2017

(54) Hot sandwich vending machine system and method

(71) Applicant: Alfredo Lavieri, Indian Land, SC (US)

(72) Inventor: Alfredo Lavieri, Indian Land, SC (US)

(21) Appl. No.: 14/824,504

(22) Filed: Aug. 12, 2015

(51) Int. Cl. G07F 9/10; G07F 7/00; G07F 11/62; A47B 31/02; G07F 17/00

(52) U.S. Cl. CPC G07F 9/105; A47B 31/02; G07F 17/0078; G07F 11/62; G07F 7/00; A47B 2031/023

(57) ABSTRACT

The invention is directed to a system and method of doing business involving the sale of freshly prepared high quality foods, particularly hot sandwiches, from a vending machine. Refrigerated food components are stocked in the vending machine. The vending machine is fully equipped with various cooking devices, such as a microwave oven, salamander oven/cheese melter, or Panini press. The user selects menu items on a display. The food components of those menu items are then delivered to the user to assemble and cook in the cooking devices. The device would bring low cost, quality meals to desired locations, such as businesses or schools.

### CROSS-REFERENCE TO RELATED APPLICATIONS

Not Applicable

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to vending machines and in particular to a hot meal vending machine system and method. Many schools, businesses, and office buildings lack sufficient capital to provide a full-service cafeteria for students, employees and visitors, but are located in areas where going out for a restaurant lunch may be impractical. Various solutions to this dilemma, such as a community refrigerator, a microwave oven, and traditional vending machines, have proven to be unsatisfactory. A hot meal vending machine system and related business method, providing various freshly-prepared hot and cold menu items from well-known restaurant chains, would provide a quality lunch without the cost of equipping and staffing a full-service cafeteria. These menu items may be specialty dishes created by and licensed from well-known restaurant chains.

### SUMMARY OF THE INVENTION

Accordingly, the invention is directed to a system and method of doing business involving the sale of freshly prepared high quality foods, particularly hot sandwiches, from a vending machine. Semi-prepared cold foods are stocked in the vending machine daily. The vending machine is fully equipped with various quick heating utilities, such as a microwave oven, salamander oven/cheese melter, or Panini press. These devices are operated by the user. The device would bring low cost, quality meals to desired locations, such as businesses.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 shows a front perspective view of the first exemplary embodiment, displaying the vending machine 10, the refrigeration section 41, the preparation section 42, the assembly table 18, and their various components.

FIG. 2 shows a front internal view of the first exemplary embodiment, displaying the refrigeration section 41, the storage racks 61, the elevator system 62, the elevator 63, the chute 64, and the dispenser area 15.

FIG. 3 shows a front view of the first exemplary embodiment, displaying the vending machine 10, the refrigeration section 41, the preparation section 42, the assembly table 18, and their various components.

FIG. 4 shows a front perspective internal view of the first exemplary embodiment, displaying the refrigeration section 41, the storage racks 61, the elevator system 62, the elevator 63, the chute 64, and the dispenser area 15.

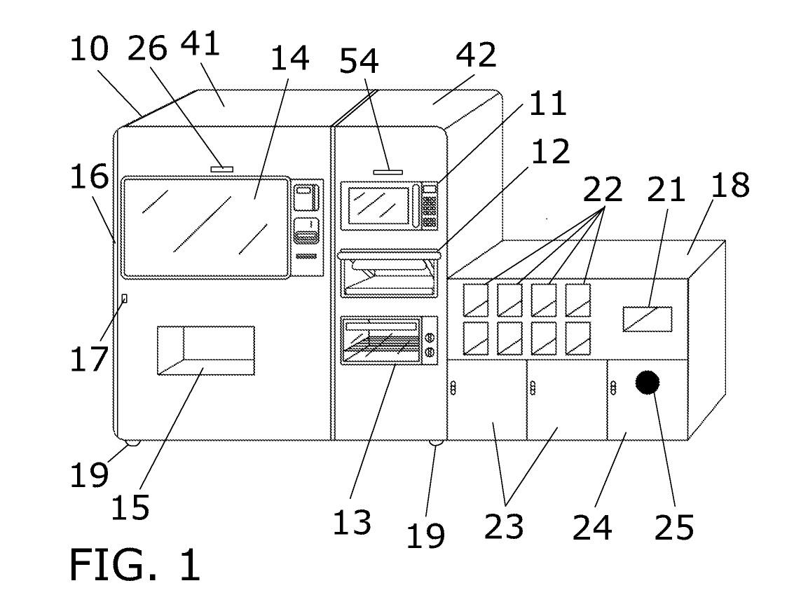

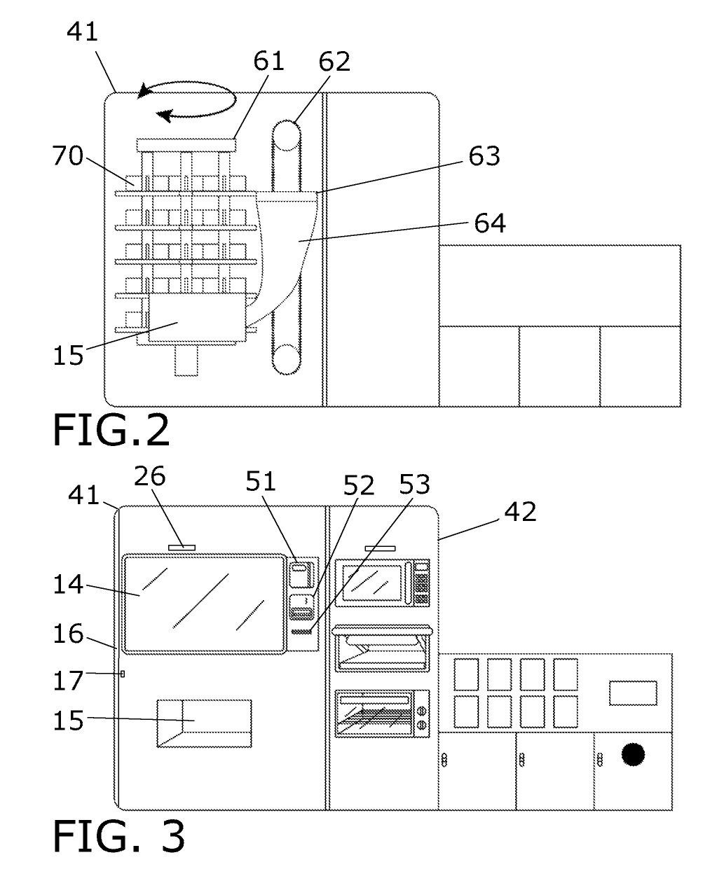

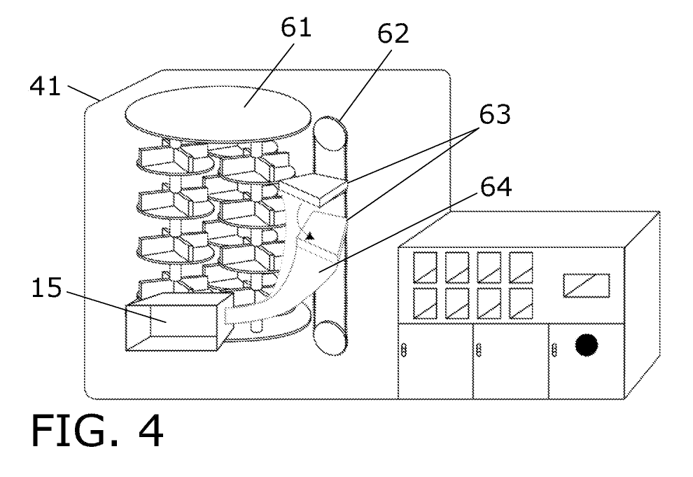

### DETAILED DESCRIPTION OF THE INVENTION

Referring now to the invention in more detail, the invention is directed to a hot meal vending machine and method for the sale of freshly prepared high quality foods, particularly hot sandwiches, from a vending machine. Cold food components 70 are stocked in the vending machine 10 daily. The food components are stocked on a rack system 61.

The vending machine 10 is fully equipped with cooking devices, such as a microwave oven 11, salamander oven/cheese melter 13, or Panini press 12. These utilities are operated by the user. The device would bring low cost, quality meals to desired locations, such as businesses or schools.

The first exemplary embodiment of the invention is further directed to a series of business methods, processes, and results that license various popular and readily identified freshly-prepared specialty menu items from well-known restaurant chains, and use these specialty menu items in the production of quality meals.

The popularly identifiable specialty dishes, such as the Personal Pan Pizza™ from Pizza Hut™, or the Smokehouse Turkey with Bacon on Three-Cheese Bread™ sandwich from Panera Bread™, would be licensed for production as part of a licensing agreement. Preferably, the licensing corporation would enjoy advertising for their restaurant chain any time the vending machine 10 is used or visible to potential customers.

Customized vending machines 10 offering various specialty menu items that are popular in different geographic regions would preferably be manufactured and marketed to schools and businesses in those geographic regions. The customized vending machines 10 would preferably incorporate specialty menu items from multiple restaurant chains, licensing specialty dishes and paying royalties to corporations and restaurant franchises owning these specialty dishes. Such licenses and royalties would be negotiated with the owning entities.

Because these particular devices are popular to display in high visibility areas, each licensing corporation could reach large numbers of potential customers that it normally would not reach. The devices could be marketed to users through websites, television, radio, print periodicals, and mail order. Business methods and practices listed above are preferable, but artisans will recognize that different business methods and practices could be employed without altering the scope of the invention.

The licensing corporation, or the school, business or other entity purchasing the system, would restock food components 70 in the refrigeration section 41, using the stocking door 16. The stocking door 16 may be locked using the lock 17. Preferably, the device would feature an assembly table 18, detachably mounted on the side of the preparation section 42, so that users may assemble their menu items, obtain cutlery and napkins from the storage compartments 22, obtain trays from the tray compartment 21, and dispose of trash in an attached trash receptacle 25. The assembly table 18 will also include storage space 23 and trash storage 24. All features and equipment will be handicapped accessible, and compliant with relevant laws and health codes.

Each device would preferably be equipped with a plurality of cooking devices (11, 12 and 13). The cooking devices may be one or more integrated microwave ovens 11, salamander oven/cheese melter 13, and one Panini press 12. The vending machine 10 may be equipped with a heat extraction system and an automatic fire extinguishing system.

The refrigeration section 41 includes one display 14 on the front of the vending machine 10. The display may be an LCD touch screen monitor 14. The display 14 includes a motion detector 26 in order to determine if a user is present. When no user is present, the display 14 may show advertising. When a user is present, the display 14 may show menu items which are available to purchase. Each device would feature both hot menu items (which require cooking in the cooking devices (11, 12, and 13) as well as refrigerated menu items, such as beverages and salads. The display 14 should be configured to transmit the order to an elevator system 62. The elevator system 62 then retrieves the appropriate food components 70 associated with the menu item selected from the storage racks 61. The food components 70 are then transferred to the elevator 63 which transmits the food component 70 to the chute 64. The food component 70 is then transferred to the dispensing area 15 via the chute 64. For high-traffic areas, the device may feature a second LCD touch screen monitor 14 on the side of the device, above the table 18, to allow more to view and consider menu items while the first user is placing an order.

The device would feature four lockable wheels 19, four inches in diameter, one on each corner of the bottom surface. Each wheel 19 would be recessed into a three-inch wheel well, leaving a one-inch gap between the device and the floor.

An alternate embodiment, featuring remote ordering, is also contemplated. The remote ordering feature would enable users to place orders while standing in line by using a smartphone or while at their desks by using a desktop or laptop computer. The ordered meal could only be removed from the dispenser area 15 by entering the user's personal company identification or school identification number on the LCD touch screen monitor 14, or by sliding the debit card or credit card used for the purchase into the debit card reader 51. Any menu item ordered will be reduced from the inventory; if the last menu item in stock is ordered via remote ordering, subsequent users attempting to order that specific menu item will be informed that it is out of stock.

The LCD touch screen monitor 14 would preferably be forty-two inches in size and will be equipped with a glare reduction screen. The LCD touch screen monitor 14 will show illustrations of menu items with prices, and will have the capacity to display advertising during periods when an order is not being placed and the motion sensor 26 does not detect a person within three feet of the front of the device. Sale of the advertising displayed by the LCD touch screen monitor 14 will provide secondary income for the business, school, or other entity purchasing the device. The LCD touch screen monitor 14 will be waterproof and be mounted in a security box, in the event that the device is installed in an outdoor location. When the motion sensor detects that a person has approached to within three feet of the front of the device, the LCD touch screen monitor 14 will change automatically from the advertising mode to the menu display mode. The user will be able to click on each illustrated menu item to obtain a display with complete nutritional information for the specific menu item.

Suggested default content for advertising would include an advertisement for the corporation providing specialty dishes for the device, information on how the food items are prepared and packaged, information about the business, school or other entity purchasing the device.

The dispenser area 15 and cooking devices (11, 12, and 13) in the device may feature a double purpose air curtain. The air curtain would cool the serving plates to prevent the users' fingers from being burned, and would also prevent any flying insects from entering the device.

The microwave oven 11 would feature a door which remains locked until the user scans a barcode on the food components 70 using the barcode scanner 54 which corresponds to a menu item appropriate for the microwave oven 11. The barcode scanner 54 may be configured to lock and activate the microwave oven 11 for a predetermined period of time based on the food components 70 which are scanned.

The Panini press 12 would feature a door which remains locked until the user scans a barcode on the food components 70 using the barcode scanner 54 which corresponds to a menu item appropriate for the Panini press 12. The barcode scanner 54 may be configured to lock and activate the microwave oven 11 for a predetermined period of time based on the food components 70 which are scanned.

The salamander oven/cheese melter 13 would feature a door which remains locked until the user scans a barcode on the food components 70 using the barcode scanner 54 which corresponds to a menu item appropriate for the salamander oven/cheese melter 13. The barcode scanner 54 may be configured to lock and activate the salamander oven/cheese melter 13 for a predetermined period of time based on the food components 70 which are scanned.

To use the device, the vending machine displays advertising, on the display 14, while the motion sensor 26 detects no user is present. When a user is detected by the motion sensor 26, the display 14 begins displaying the available menu items. The user selects various hot and cold menu items using the LCD touch screen monitor 14. The device may offer the option of modifying a menu item, such as adding extra cheese to a pizza or sandwich, for a small additional fee. A running total price for all chosen menu items and options, and a Proceed To Checkout option, would be displayed on the LCD touch screen monitor 14. When the user has finished selecting items, the Proceed to Checkout option is selected, and the user pays for the selected items using a card in the card reader 51, or currency in the bill/coin receiver 52. A receipt is then printed for the user from the receipt printer 53. The display 14 then communicates the required food components 70 to the elevator system 62. The elevator system 62 then retrieves the appropriate food components 70 from the storage racks 61 using the elevator 63. Once collected, the elevator 63 transmits the food components 70 to the chute 64 which transmits the food components 70 to the dispenser area 15.

The user then collects the food components 70 from the dispenser area 15 and assembles the menu item on the assembly table 18. At the assembly table 18 the user may collect utensils from the utensil compartments 22 or trays from the tray compartment 21. Additional utensils or other items may be stored underneath the assembly table 18 in the storage cabinets 23. Any trash or waste may be disposed of in the trash cabinet 24, through the trash receptacle 25. Once the user has finished assembling the menu item, they scan a barcode for their menu item using the barcode scanner 54. The barcode scanner 54 is configured to unlock the appropriate cooking device (11, 12, or 13). The user then places the menu item inside the appropriate cooking device (11, 12, or 13). When the door for the appropriate cooking device (11, 12, or 13) is shut the barcode scanner locks the door and activates the appropriate cooking device (11, 12, or 13) for a predetermined period of time. The period of time is determined based on the menu item which the user ordered.

Electronic components of the device would preferably include a microwave oven 11, a Panini press 12, a salamander oven/cheese melter 13, an LCD touch screen monitor 14, a dispenser area 15, a storage rack 61, an elevator system 62, a bill/coin receiver 52, a card reader 51, a receipt printer 53, a microprocessor, a memory unit, and a power source. The power source would preferably be a grounded power cord connected to a standard grounded wall outlet. The LCD touch screen monitor 14 would preferably measure forty-two inches diagonally, and would preferably be equipped with a motion sensor 54 to display different advertisements when a person approaches the device. The vending machine 10 would preferably incorporate a refrigeration section 41, and would preferably be forty-two inches deep, seventy-eight inches tall, and eighty-three inches wide.

The microwave ovens 11, Panini press 12, salamander oven/cheese melter 13, and dispenser area 15 would preferably be manufactured from rigid, durable, heat-resistant, easily cleaned materials, such as stainless steel and aluminum. The lock 17, bill/coin receiver 52, card reader 51, and receipt printer 53 would preferably be manufactured from rigid, durable metals that are tamper-resistant, such as stainless steel. The LCD touch screen monitors 14, stocking door 16, refrigeration section 41, preparation section 42, memory unit and microprocessor would preferably be manufactured from rigid, durable materials, such as steel, aluminum, copper, and high-impact plastic. The wheels 19 would preferably be manufactured from rigid, durable materials, such as steel or aluminum, featuring solid tires manufactured from durable, flexible materials such as rubber or silicone. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

1. A vending machine system, comprising:
a refrigeration section;
said refrigeration section having a stocking door and a lock for said stocking door;
said refrigeration section having a display;
said refrigeration section having a dispenser area;
said refrigeration section having a payment receptacle;
said refrigeration section having storage racks;
said refrigeration section having an elevator system;
said refrigeration section having food components;
said refrigeration section having a chute;
a preparation section;
said preparation section having cooking devices;
said preparation section having a barcode scanner;
an assembling table; and
a central processing unit;
said central processing unit having a microprocessor;
said central processing unit having a memory device; and
said central processing unit having a transmitter and receiver;
wherein said display is configured to accept a user's order of a menu item, whether the user is present or ordering remotely via an electronic device such as a cell phone, and communicate the order to the elevator system; said elevator system is configured to collect the appropriate food components from said storage racks and dispense food components to the dispenser area using the chute.

2. The vending machine system of claim 1, wherein said cooking devices are one or more of a microwave, a panini press, or a salamander/broiler oven.

3. The vending machine system of claim 1, wherein said display is an LCD touch screen monitor provided within a waterproof security box;
said display being configured to list menu items which are available for purchase;
said display being configured for user input.

4. The vending machine system of claim 3, further comprising a motion sensor; said motion sensor being configured to detect the presence of users.

5. The vending machine system of claim 4, wherein said display is further configured to display advertising when no user is present and menu items when user is present.

6. The vending machine system of claim 1, wherein said barcode reader may be used to scan a barcode on said food components; said barcode reader being configured to unlock the appropriate cooking device based on said food components; said barcode reader being configured to activate the appropriate cooking device for a predetermined time based on said food components.

7. The vending machine system of claim 1, wherein said payment receptacles include one or more of a card reader or bill/coin receiver.

8. The vending machine system of claim 1, wherein said storage racks are stocked with said food components.

9. The vending machine system of claim 1, wherein said food components include meats, cheeses, breads, soups, vegetables, fruits, or drinks.

10. The vending machine system of claim 1, further comprising a plurality of wheels; said wheels being attached to the bottom of said vending machine system.

11. The vending machine system of claim 1, wherein said assembly table is removably attached to said preparation section.

12. The vending machine system of claim 1, wherein said assembling table further comprises utensil compartments, tray compartments, storage cabinets, and trash cabinets.

13. The vending machine system of claim 12, wherein said utensil compartments are equal in number to eight, said tray compartment is equal in number to one, said storage cabinets are equal in number to two, and said trash cabinet is equal in number to one.

14. The vending machine system of claim 12, wherein said trash cabinet further comprises a trash receptacle.

15. The vending machine system of claim 13, wherein said trash cabinet further comprises a trash receptacle.

16. The vending machine system of claim 1, wherein said display is configured to accept remote orders from separate electronic devices such as cell phones, telephones, computers, or tablets, employing voice recognition, SMS text, and e-mail capabilities resident within the microprocessor and memory device.

17. A method of doing business by manufacturing and marketing the vending machine system of claim 1, comprising:
(a) the business entity manufacturing customized vending machines offering various specialty menu items that are popular in different geographic regions;
(b) the business entity marketing sales and leases of the customized vending machines to schools, businesses, and similar locations in said geographic regions;
(c) the customized vending machines preferably incorporating specialty menu items from multiple restaurant chains, such that the business entity negotiates licenses and royalties for specialty dishes owned by restaurant chains; and
(d) the customized vending machines having food components which may be used to assemble the specialty menu items, and other menu items in the public domain.

18. The method of doing business of claim 17, wherein the customized vending machines may be marketed through websites, television, radio, print periodicals, and mail order.

19. The method of doing business of claim 17, wherein default content for advertising may include advertisement for the restaurant chains providing specialty menu items for the customized vending machine, information on how the specialty menu items are prepared and packaged, and information about the business, school or other location leasing or purchasing the customized vending machine.

20. The method of doing business of claim 17, wherein the business entity, or the business, school or other location leasing or purchasing the customized vending machine, restocks food components in the refrigeration section and recovers any currency in the payment receptacle pursuant to terms of the lease or purchase.
